(19) United States
(12) Patent Application Publication
(10) Pub. No.: US 2026/0121279 A1
(43) Pub. Date: Apr. 30, 2026

(54) SLOT ANTENNA FOR LED STRIP LIGHTING AND APPLICATIONS THEREOF

(71) Applicant: Qorvo US, Inc., Greensboro, NC (US)

(72) Inventors: Marcel Johannes Gerhardus Vrijkorte, Geffen (NL); Angel Ramos, Berkel en Rodenrijs (NL); Jan-Willem Zweers, Nieuwleusen (NL); Timo Lampe, Zeist (NL); Jan Wielsma, Culemborg (NL)

(21) Appl. No.: 19/269,749

(22) Filed: Jul. 15, 2025

Related U.S. Application Data
(60) Provisional application No. 63/686,379, filed on Aug. 23, 2024.
(60) Provisional application No. 63/739,742, filed on Dec. 30, 2024.

(51) Int. Cl. H01Q 1/22; F21S 4/28; F21V 23/00; H01Q 9/04; H01Q 13/10; H01Q 23/00

(52) U.S. Cl. CPC H01Q 1/2283; F21S 4/28; F21V 23/005; H01Q 9/0457; H01Q 13/106; H01Q 23/00

(57) ABSTRACT

One aspect of the present disclosure pertains to slot antennas for light-emitting diode (LED) strip lighting having an integrated communications module. A slot antenna and LED strip lighting with the integrated communications module may be provided as part of a lighting device. In some embodiments, the lighting device includes a printed circuit board (PCB) including a plurality of LEDs mounted on the PCB, a radio communications module mounted on the PCB, and a coplanar coupling structure coupled to the radio communications module. In some embodiments, the PCB is configured to feed the slot antenna via the coplanar coupling structure. In some embodiments, the slot antenna is disposed parallel to, and separated from, the coplanar coupling structure.

### CROSS REFERENCE(S) TO RELATED APPLICATION(S)

The application claims the benefit of U.S. Provisional Application No. 63/686,379, filed Aug. 23, 2024, and U.S. Provisional Application No. 63/739,742, filed Dec. 30, 2024, both of which are hereby expressly incorporated by reference herein in its entirety.

### FIELD OF THE DISCLOSURE

The technology disclosed herein relates generally to slot antennas for light-emitting diode (LED) strip lighting, and more particularly to slot antennas for LED strip lighting having an integrated communications module.

### BACKGROUND

LED lighting offers many advantages over traditional lighting systems (e.g., such as incandescent lighting) including reduced energy consumption, increased lifetime and durability, and reduced cost, among other advantages. As an example, LED strip lighting, which includes a printed circuit board (PCB) having an array of surface mounted LEDs (SMD LEDs) mounted thereon, has become prevalent in a variety of applications such as home and industrial applications. In particular, lighting devices incorporating such LED strip lighting may further include various electronic components such as drivers, antennas, radio communication devices, etc., that provide for wireless control of the LED strip lighting. Generally, small area and low height antennas are desirable to prevent unwanted shadows on lighting fixtures. However, when the lighting fixture includes a large area metal back plate armature (or reflector), the armature may interfere with low height antenna solutions. Moreover, for antenna efficiency, the antenna should point away from the armature and away from any PCBs mounted thereon, but such a solution may generate undesirable shadows in the light pattern. Thus, existing LED strip lighting implementations have not proved entirely satisfactory in all respects.

### SUMMARY

Embodiments of the present disclosure include systems, devices, and methods for providing slot antennas for LED strip lighting having an integrated communications module.

In an exemplary aspect, a lighting device includes a printed circuit board (PCB) including a plurality of light-emitting diodes (LEDs) mounted on the PCB, a radio communications module mounted on the PCB, and a coplanar coupling structure coupled to the radio communications module. In some embodiments, the PCB is configured to feed a slot antenna via the coplanar coupling structure. In some embodiments, the slot antenna is disposed parallel to, and separated from, the coplanar coupling structure.

In some embodiments, the lighting device further includes a metal armature including an opening that defines a slot, where the slot provides the slot antenna. In some embodiments, wherein the PCB is mechanically attached to the metal armature.

In some embodiments, the slot includes a half-wavelength slot.

In some embodiments, the metal armature is configured to provide a radiator for the slot antenna.

In some embodiments, the slot includes a Z-shaped slot or a V-shaped slot.

In some embodiments, the PCB comprises a single-layer rigid PCB.

In some embodiments, the mechanically attached PCB covers about half of the slot.

In some embodiments, the PCB is configured to capacitively or inductively feed the slot antenna via the coplanar coupling structure.

In some embodiments, the lighting device further includes an LED driver mounted on the PCB, where the LED driver is coupled to the radio communications module and to the plurality of LEDs to drive the plurality of LEDs.

In some embodiments, the lighting device further includes a matching network coupled to the coplanar coupling structure and to an output of the radio communications module.

In some embodiments, the coplanar coupling structure includes a coupling trace, the coupling trace including a conductive trace of the PCB.

In another exemplary aspect, a lighting device includes an armature including a slot integral to the armature, where the slot provides the slot antenna. In some embodiments, the lighting device further includes a light-emitting diode (LED) strip printed circuit board (PCB) mechanically attached to the armature. In some embodiments, the lighting device further includes a radio chip mounted on the LED strip PCB and coupled to a coupling trace defined by a conductive trace of the LED strip PCB. In some embodiments, the LED strip PCB is configured to capacitively or inductively feed the slot antenna via the coupling trace.

In some embodiments, the coupling trace defines a first conductive plane, and the armature defines a second conductive plane parallel to the first conductive plane and separated from the first conductive plane by a distance substantially equal to a thickness of an insulating substrate of the LED strip PCB.

In some embodiments, the slot includes a Z-shaped slot or a V-shaped slot.

In some embodiments, the LED strip PCB includes a single-layer rigid PCB.

In some embodiments, the LED strip PCB covers about half of the slot.

In some embodiments, the radio chip includes a radio frequency (RF) terminal that provides an RF output of the radio chip, and where the RF output is coupled to the coupling trace.

In some embodiments, a matching network is coupled between the RF output and the coupling trace.

In another exemplary aspect, a lighting device includes an armature including a Z-shaped slot that provides a slot antenna. In some embodiments, the lighting device further includes a printed circuit board (PCB) attached to the armature and covering about half of the Z-shaped slot. In some embodiments, the PCB includes an array of light-emitting diodes (LEDs), an LED driver coupled to the array of LEDs to drive the LEDs, and a radio chip coupled to the LED driver and to a matching network connected to an output of the radio chip. In some embodiments, the matching network is further coupled to a conductive coupling trace of the PCB. In some embodiments, the PCB is configured to capacitively or inductively feed the Z-shaped slot via the conductive coupling trace.

In some embodiments, the Z-shaped slot has a first length that is equal to about half a wavelength of a target frequency, and the conductive coupling trace has a second length that is equal to about a quarter of the wavelength of the target frequency.

Additional aspects, features, and advantages of the present disclosure will become apparent from the following detailed description.

### BRIEF DESCRIPTION OF THE DRAWINGS

The accompanying drawing figures incorporated in and forming a part of this specification illustrate several aspects of the disclosure, and together with the description, serve to explain the principles of the disclosure.

FIG. 1A illustrates a top-down perspective view of a lighting fixture, in accordance with some embodiments.

FIG. 1B illustrates a bottom-up perspective view of the lighting fixture, in accordance with some embodiments.

FIG. 1C illustrates an enlarged view of a portion of the light fixture of FIG. 1B, in accordance with some embodiments.

FIG. 2 illustrates a top-down view of a portion of a printed circuit board (PCB) mounted on an armature including a slot, in accordance with some embodiments.

FIG. 3 illustrates a simplified top-down view of an electric/RF schematic that shows components of the PCB used for coupling to the slot, in accordance with some embodiments.

FIG. 4 illustrates a top-down perspective view of a portion of the PCB mounted on the armature, in accordance with some embodiments.

FIG. 5 illustrates another top-down perspective view of a portion of the PCB mounted on the armature, in accordance with some embodiments.

FIGS. 6, 7, 8, 9, and 10 illustrate various exemplary simulation results for a light fixture including a Z-shaped slot and an attached PCB, in accordance with some embodiments.

### DETAILED DESCRIPTION

For purposes of promoting an understanding of the principles of the present disclosure, reference will now be made to the embodiments illustrated in the drawings, and specific language will be used to describe the same. It is nevertheless understood that no limitation to the scope of the disclosure is intended. Any alterations and further modifications to the described systems, devices, and methods, and any further application of the principles of the present disclosure are fully contemplated and included within the present disclosure as would normally occur to one skilled in the art to which the disclosure relates. In particular, it is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately.

In contrast to conventional lighting systems (e.g., such as incandescent lighting) light-emitting diode (LED) lighting is more energy efficient, has a longer lifetime, better durability, and reduced cost, among other advantages. In one example, LED lighting may be implemented as LED strip lighting, which has become prevalent in a variety of applications including home and industrial applications (e.g., such as office lighting, bathroom lighting, supermarket lighting, classroom lighting, hallway lighting, etc.). In various cases, LED strip lighting includes a printed circuit board (PCB) having an array of surface mounted LEDs (SMD LEDs) mounted thereon. In various examples, LED strip lighting may be fabricated on rigid or flexible substrates and are available in a wide range of fixed and variable colors and brightness. Lighting devices incorporating LED strip lighting may also include various other electronic components such as drivers, antennas, radio communication devices, etc., that provide for wireless control of the LED strip lighting. In general, small area and low height antennas are desirable to prevent unwanted shadows on lighting fixtures. However, when the lighting fixture includes a large area metal back plate armature (or reflector), the armature may interfere with low height antenna solutions. Moreover, for antenna efficiency, the antenna should point away from the armature and away from any PCBs mounted thereon, but such a solution may generate undesirable shadows in the light pattern. Thus, existing LED strip lighting implementations have not proved entirely satisfactory in all respects.

Embodiments of the present disclosure offer advantages over the existing art, though it is understood that other embodiments may offer different advantages, not all advantages are necessarily discussed herein, and no particular advantage is required for all embodiments. For example, embodiments discussed herein include systems, devices, and methods for providing slot antennas for LED strip lighting having an integrated communications module, that effectively serve to overcome various shortcomings of existing implementations. In some embodiments, a lighting fixture includes a large area metal back plate armature (or reflector) having a half-wavelength slot formed therein to provide a slot antenna integral to the armature, where the armature serves as a radiator for the slot antenna. In various cases, the half-wavelength slot formed in the armature may include a V-shaped slot or a Z-shaped slot, as discussed in more detail below. By using a half-wavelength slot in the metal back plate (the armature), embodiments of the present disclosure provide an efficient antenna that remains compatible with standard production practice.

In an example, the armature provides an infinite ground plane onto which a PCB (with an array of SMD LEDs mounted thereon) is mechanically, but not electrically, attached to the armature. For instance, the PCB may be attached to the armature by way of screws, bolts, rivets, or other appropriate fasteners. Alternatively, in some embodiments, the PCB may be attached to the armature by way of an adhesive backing provided along a backside of the PCB. In some embodiments, the PCB includes a single-layer rigid PCB that includes a linear array of SMD LEDs mounted thereon. For purposes of the discussion provided herein, a PCB with an array of LEDs may be equivalently referred to as an “LED strip PCB” or “LED PCB”. By way of example, the single-layer PCB includes a conductive material (e.g., such as copper) on only one side of an insulating substrate (e.g., such as fiberglass, a fiberglass-epoxy laminate, or other suitable material), where the conductive material is patterned to provide conductive traces for coupling to the array of LEDs and for other electronic components mounted thereon and/or electronic circuits defined therein, in accordance with embodiments of the present disclosure. In particular, in various embodiments, a radio communications module (or radio chip) is mounted onto the single-layer PCB in addition to the array of LEDs. By way of example, the radio chip includes a radio frequency (RF) output that couples to a matching and/or filter network that is separate from the radio chip but which is also disposed on the LED strip PCB. The matching and/or filter network is further connected to a coupling trace provided by a conductive PCB trace. In various embodiments, the LED strip PCB is attached to the armature near the half-wavelength slot (the slot antenna) in the metal back plate (the armature) so that the feeding of the half-wavelength slot is provided via a coplanar coupling structure (the coupling trace) on the LED strip PCB that is parallel to a surface of the armature (and thus parallel to the half-wavelength slot) and which covers at least some of the half-wavelength slot (e.g., such as half of the slot antenna, in some cases). In various embodiments, the coplanar coupling structure may capacitively and/or inductively feed the half-wavelength slot (the slot antenna). The disclosed LED strip PCB (including the radio chip and coupling structure) and slot antenna, where the armature is used as a radiator for the slot antenna, thus provide for efficient wireless control of the array of LEDs mounted on the LED strip PCB.

It is also noted that as the armature may already include mounting holes for the LED strip PCB, the disclosed slot antenna can be provided at no additional cost. Another advantage is that there are no issues with sticking fragile wires out of the LED strip PCB that can be bent (and cause detuning) or can cause shadowing in the lighting pattern. In addition, the structure disclosed herein is easy to fabricate and is reproducible. For instance, the alignment of the antenna slot and LED strip PCB (including the radio chip and coupling structure) is not an issue. Further, the mounting tolerance of the LED strip PCB is much smaller than what is needed for an efficient antenna, and it is robust for manufacturing. Generally, embodiments of the present disclosure can therefore be used to manufacture inexpensive, mechanically robust and scalable light armatures that can be readily implemented in a variety of consumer and industrial applications, including a variety of Internet-of-Things (IoT) applications. Additional details of embodiments of the present disclosure are provided below, and additional benefits and/or other advantages will become apparent to those skilled in the art having benefit of the present disclosure.

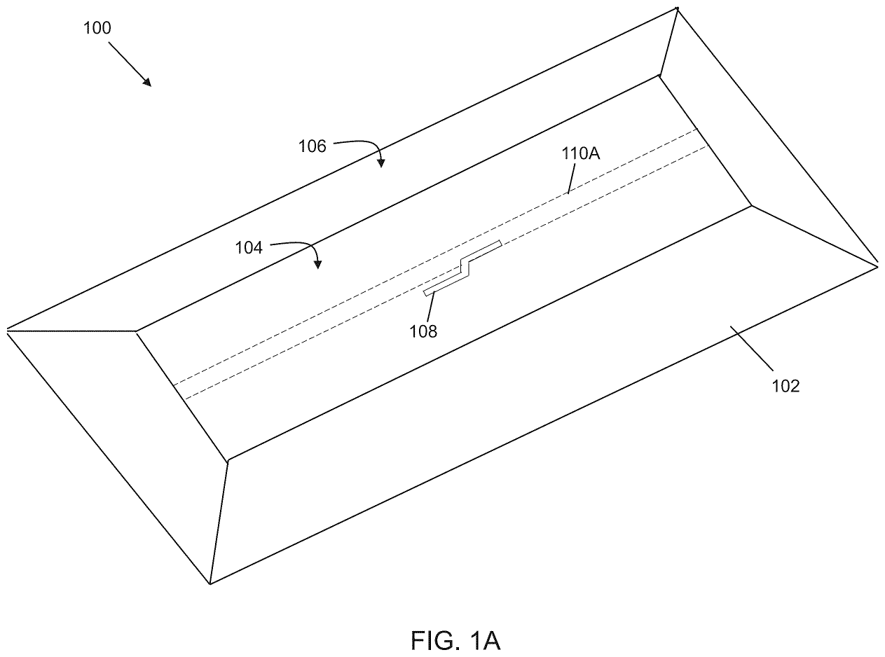

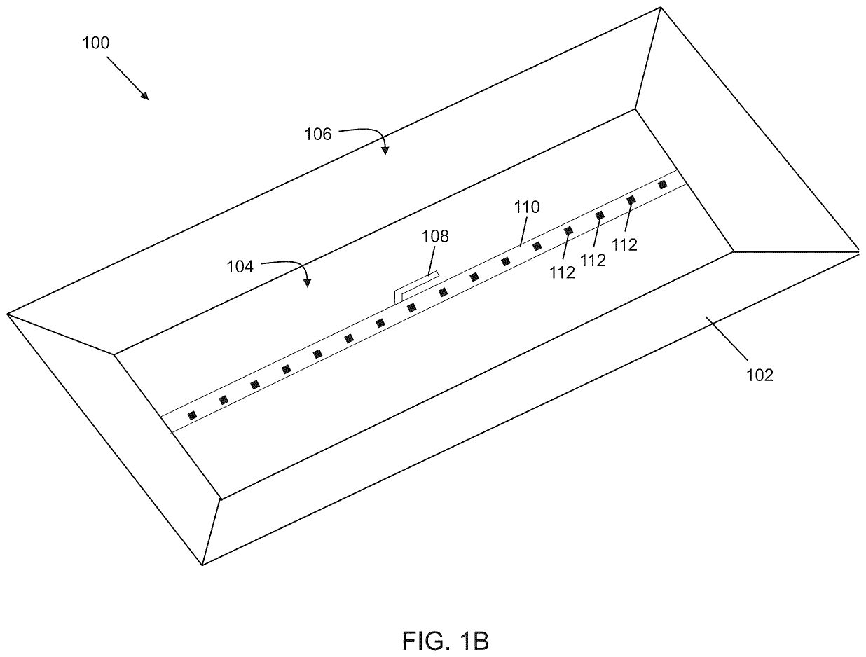

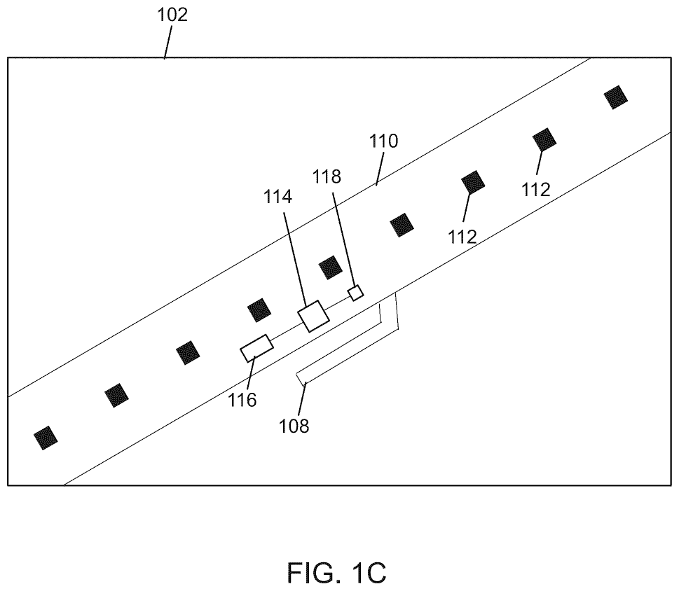

Referring now to FIG. 1A and FIG. 1B, FIG. 1A illustrates a top-down perspective view of a lighting fixture 100 and FIG. 1B illustrates a bottom-up perspective view of the lighting fixture 100, in accordance with some embodiments. In various examples, the lighting fixture 100 may be attached to an overhead structure (e.g., such as a ceiling), and in some cases the lighting fixture 100 may be suspended by cables, chains, stanchions, or other suitable connectors. While a particular embodiment of a lighting fixture 100 is shown and described, it will be understood that embodiments of the present disclosure may be employed within a variety of other types and/or configuration of lighting fixtures without departing from the scope of the present disclosure.

As shown, the lighting fixture 100 includes an armature 102 comprised of a large area conductive metal back plate. In some examples, the armature 102 may provide a reflector to reflect and direct light generated (e.g., by LEDs) within the lighting fixture 100. The armature 102, as previously noted, provides an infinite ground plane onto which an LED strip PCB is mechanically attached, as described in more detail below. In some embodiments, the armature 102 may be formed of sheet metal, aluminum, or other conductive material. The armature 102, as illustrated, also has a substantially flat region 104 from which sloped flat regions 106 extend on each side of the flat region 104. In some cases, instead of the sloped flat regions 106, the armature 102 may include convex or concave regions that extend from each side of the flat region 104. More generally, in some embodiments, the armature 102 may have an overall parabolic shape or concave shape. To be sure, while some embodiments of shapes of the armature 102 have been provided, it will be understood that the exemplary shapes disclosed herein are not meant to be limiting.

In various embodiments, a half-wavelength slot 108 (or slot 108) is formed within the armature 102 and is an integral part of the armature 102, as the slot 108 is defined by an opening formed in the conductive metal back plate that provides the armature 102. By way of example, the slot 108 is sized so as to resonate at a desired frequency band (or target frequency band), thereby forming a slot antenna suitable for use in wireless communication and control of the LEDs disposed on the LED strip PCB. In various embodiments, the armature 102 also serves as a radiator for the slot antenna. As described in more detail below, slot 108 has a length that is equal to about half the wavelength of radiation in the desired frequency band (or target frequency band). In some embodiments, the desired frequency band (or target frequency band) may be around 2.4-2.5 GHz. As such, and in some examples, the slot 108 may have a length equal to about 55-65 mm. It will be understood, however, that different frequency bands may be implemented by appropriately sizing the slot 108, without departing from the scope of the present disclosure. In the illustrated example, the slot 108 has a Z-shape, but in other examples, the slot 108 may alternatively have a V-shape, as discussed in more detail below. In addition, since the slot 108, and the slot antenna provided thereby, is integral to the armature 102, no additional external antenna is needed. Further, the slot antenna provided by the slot 108 is cost-effective, mechanically robust, and does not obscure light generated (e.g., by LEDs) within the lighting fixture 100.

As shown in FIG. 1B, a PCB 110 including a plurality of LEDs 112 is attached to an interior surface of the armature 102. As described above, the PCB 110 may be attached to the armature 102 by way of screws, bolts, rivets, or other appropriate fasteners. In some cases, the PCB 110 may be attached to the armature 102 by way of an adhesive backing provided along a backside of the PCB 110. In various embodiments, the PCB 110 includes a single-layer rigid PCB onto which the LEDs 112 are mounted. In some alternative embodiments, the PCB 110 may include a single-layer flexible PCB, a multi-layer rigid PCB, or a multi-layer flexible PCB. The LEDs 112 collectively define an array of LEDs 112 or a linear array of LEDs 112 that provide the light source for the light fixture 100. In some embodiments, the LEDs 112 include surface mounted LEDs (SMD LEDs) that are electrically coupled to conductive traces on the PCB 110. The PCB 110 with the array of LEDs 112 provides the LED strip PCB (or LED PCB), as described above. As described in more detail below, a radio communications module (or radio chip) is also mounted onto the PCB 110 in addition to the array of LEDs 112. As shown, the PCB 110 is attached to the armature 102 near the slot 108 such that the PCB 110 covers at least some of the slot 108 (e.g., such as half of the slot 108, in some cases), to provide for capacitive and/or inductive coupling between a coupling structure on the PCB 110 and the slot 108. FIG. 1A includes dashed lines 110A that correspond to the PCB 110 and which more clearly illustrate an example of the PCB 110 covering at least some of the slot 108. In various embodiments, the PCB 110 may include additional components such as drivers, a matching and/or filter network, a coplanar coupling structure, other circuitry, etc. Further, in some examples, the light fixture 100 may include other components such as a heat sink, power supply connection, other hardware or electrical components or circuits, etc.

Referring to FIG. 1C, illustrated therein is an enlarged view of a portion of the light fixture of FIG. 1B, including the PCB 110 and the array of LEDs 112. As also shown in the example of FIG. 1C, a radio communications module 114 (or radio chip 114) is mounted onto the PCB 110. For example, the radio chip 114 may be mounted onto the PCB 110 so as to be electrically coupled to a plurality of conductive traces on the PCB 110. In some embodiments, the radio chip 114 is coupled to one or more LED drivers 116 mounted on the PCB 110 via conductive traces of the PCB 110, and the LED driver(s) 116 are in turn coupled to the LEDs 112 (e.g., via conductive traces on the PCB 110) to drive the LEDs 112. As shown, the radio chip 114 is also coupled to a matching and/or filter network 118. As discussed in more detail below, the matching and/or filter network 118 is further connected to a coupling trace provided by a conductive trace of the PCB 110. In various embodiments, the PCB 110 capacitively and/or inductively feeds slot antenna (provided by the slot 108) via a coplanar coupling structure (the coupling trace) on the PCB 110 that is connected to the matching and/or filter network 118, and which is parallel to a surface of the armature 102. In addition, the PCB 110 may cover at least some of the slot 108, as shown.

The radio chip 114, by way of example, is a system-on-a-chip (SOC) having a plurality of components such as an integrated radio module (operating between about 2.4-2.5 GHz), a microcontroller, a power management unit, memory, integrated baluns and RF filters, and a security engine, among other features. In some embodiments, the integrated radio module provides support for multiple communications protocols such as Bluetooth Low Energy and IEEE 802.15.4 communications. In some examples, the radio chip 114 also includes a pulse width modulation (PWM) interface and an inter-integrated circuit (I2C) interface to generate PWM signals and I2C signals, respectively, which can be used to control the LED driver(s) 116, among other interfaces (e.g., such as an analog-to-digital converter interface, a universal synchronous receiver-transmitter interface, and a serial peripheral interface). Generally, and in various embodiments, the radio chip 114 may include a multi-standard low-power communications controller that can be deployed in any of a plurality of IoT end node applications such as connected lighting, sensors, smart plugs, thermostats, or wearables. In addition, and in some embodiments, the radio chip 114 may include GaN-based devices and/or circuits, such as GaN-based depletion mode devices and circuits. For instance, such GaN-based devices and circuits may include, in various examples, power amplifiers (PAs), switches, mixers, low-noise amplifiers (LNAs), filters, duplexers, multiplexers, modulators, multipliers, transceivers, or other GaN-based circuits and/or devices.

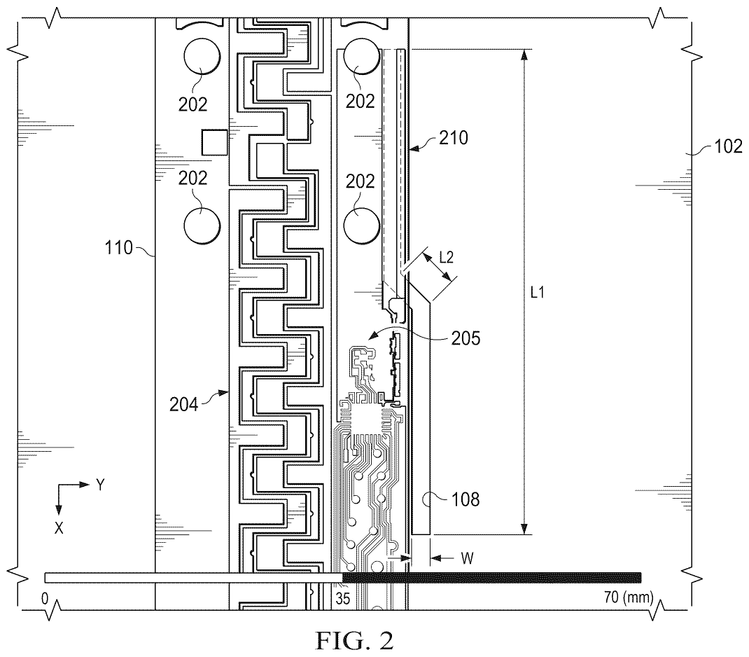

Referring now to FIG. 2, illustrated therein is a more detailed top-down view of a portion of the PCB 110 mounted on the armature 102. The example of FIG. 2 also illustrates fasteners 202 (e.g., screws, bolts, rivets) that are used to mechanically, but not electrically attach the PCB 110 to the armature 102. In addition, FIG. 2 shows various conductive traces on the PCB 110. For example, conductive traces 204 are provided for mounting of the array of LEDs 112, discussed above. Conductive traces 205 are also provided for the radio chip 114, the matching and/or filter network 118, the coplanar coupling structure (the coupling trace), and other associated features, as described in more detail below. In various embodiments, a tinning process (e.g., such as by electroplating, bath immersion, or electroless tin plating) may be performed to protect the conductive traces 204, 205 from oxidation prior to subsequent soldering of the LEDs 112, the radio chip 114, passive devices (e.g., resistors, capacitors, inductors), or other electronic components.

In particular, FIG. 2 illustrates an exemplary length ‘L1’ associated with the slot 108. In an embodiment, the length ‘L1’ may be equal to about 57.8 mm. In some cases, the length ‘L1’ may be in a range of between about 55-60 mm. Also illustrated is an exemplary length ‘L2’ of a diagonal portion of the Z-shaped slot 108 of FIG. 2. In some embodiments, the length ‘L2’ may be equal to about 5 mm. In some cases, the length ‘L2’ may be in a range of between about 4.5-5.5 mm. The length ‘L2’ may be even longer in some cases, assuming a corresponding adjustment in the length ‘L1’ is also made, as noted below. In some examples, an exemplary width ‘W’ of the slot 108 may be equal to about 2 mm. In some cases, the width ‘W’ may be in a range of between about 1.5-2.5 mm. In some embodiments, the total (or electrical) length of the slot 108 may be equal to L1+L2, where the total (or electrical) length is measured over a centerline of the slot 108. As previously discussed, the length of the slot 108 will determine the frequency band for the slot antenna provided by the slot 108. For a desired frequency band (or target frequency band) of around 2.4-2.5 GHz, the total (or electrical) length of the slot may be around 55-65 mm. Generally, the total (or electrical) length of the slot 108 may be varied so that the slot 108 is resonant at the target frequency band. In some cases, one or both of the lengths L1 and L2 may be varied so that the slot 108 is resonant at the target frequency band. As one example, consider that the length ‘L2’ is equal to or greater than about 10 mm. In such an example, and assuming the desired frequency band for the slot 108 remains the same (e.g., such as around 2.4-2.5 GHz), the length ‘L1’ may be correspondingly reduced to maintain a total length of the slot 108 (L1+L2) that is suitable to provide the target frequency band.

FIG. 2 further illustrates the alignment between the PCB 110 and the slot 108. In some embodiments, the PCB 110 covers about half of the slot 108, while the other half of the slot 108 is adjacent to the PCB 110. Thus, as shown in the illustrated example, an edge 210 of the PCB 110 may pass through the diagonal portion of the Z-shaped slot 108, thereby substantially bisecting the slot 108. To be sure, in various embodiments, the PCB 110 need not cover exactly half of the slot 108. For example, as discussed further below, a misalignment between the PCB 110 and the slot 108 of about +/−1 mm will still provide an efficient and robust slot antenna. In at least some cases, the misalignment between the PCB 110 and the slot 108 may be up to about +/−2 mm while still providing an antenna with good efficiency.

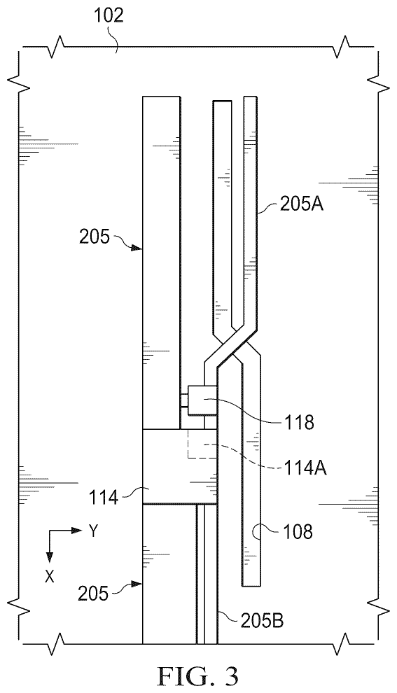

With reference to FIG. 3, illustrated therein is a simplified top-down view of an electric/RF schematic that shows components of the PCB 110 used for coupling to the slot 108. More particularly, FIG. 3 shows some of the conductive traces (the conductive traces 205) of the PCB 110, and components formed thereon, used for coupling to the slot antenna provided by the slot 108 formed within the armature 102. As shown, the conductive traces 205 include a first coupling trace 205A and a second coupling trace 205B, where each of the first and second coupling traces 205A, 205B have a length equal to about a quarter of the wavelength of radiation in the desired frequency band (or target frequency band). In some embodiments, the coupling trace 205B may be a ground trace. As previously noted, the total length of the slot 108 is equal to about half the wavelength of radiation in the desired frequency band (or target frequency band). In various examples, the conductive traces 205 (disposed on the PCB 110) define a first conductive plane and the metal back plate of the armature 102 defines a second conductive plane parallel to the first conductive plane and separated from the first conductive plane by a distance substantially equal to a thickness of the insulating substrate of the PCB 110.

FIG. 3 also illustrates the radio chip 114 mounted onto the PCB 110 and coupled to the conductive traces 205. In some embodiments, the radio chip 114 includes an RF terminal 114A that provides the RF output of the radio chip 114. The RF terminal 114A may include integrated baluns and RF filters, and the output of the RF terminal 114A may have an impedance of about 50 Ohms. In various embodiments, the matching and/or filter network 118 is electrically coupled, by a conductive trace of the PCB 110, to the RF terminal 114A (to the RF output of the radio chip 114). In some embodiments, and if needed, the radio chip 114 may be placed at some distance further from the slot antenna, provided by the slot 108, by using a 50 Ohm transmission line.

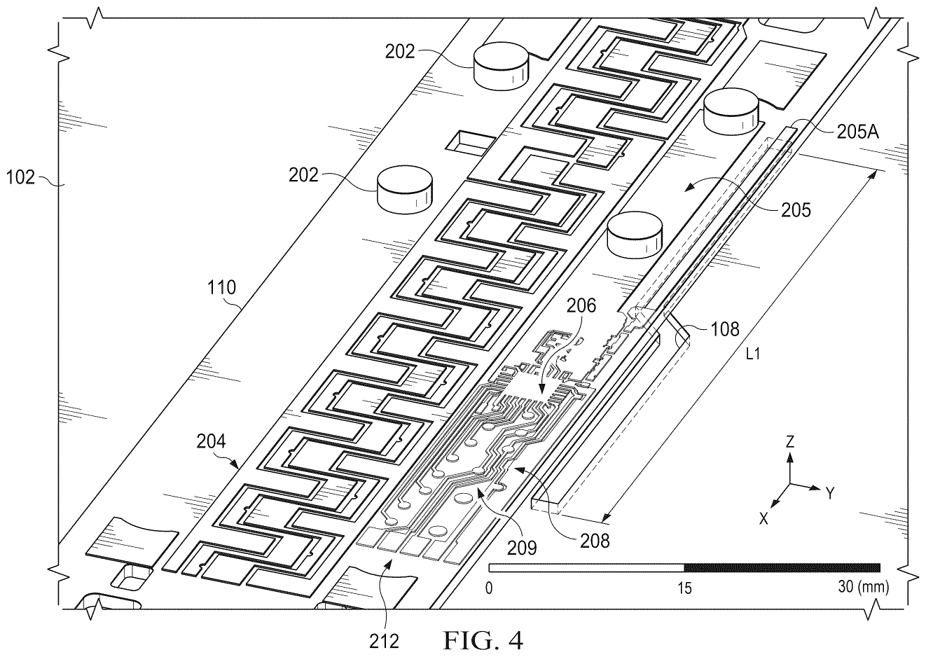

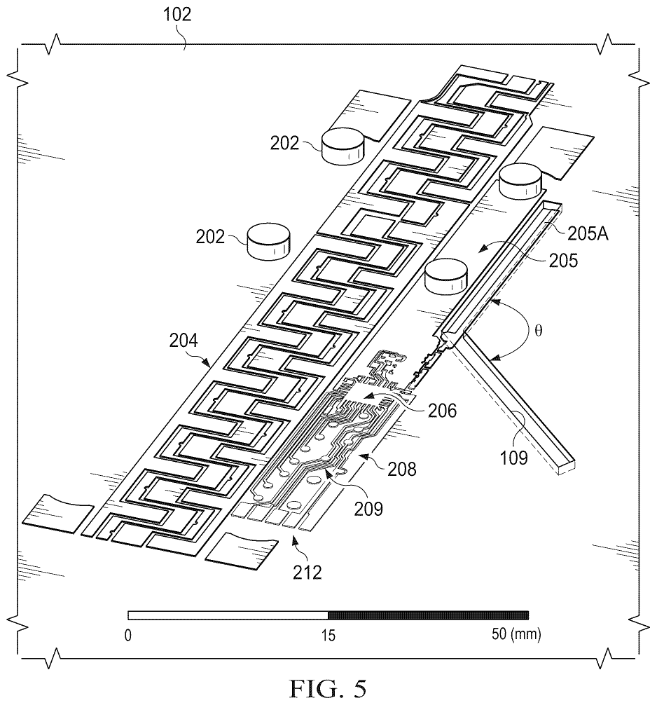

As shown, the matching and/or filter network 118 is further coupled to the coplanar coupling structure (the coupling trace 205A). In various embodiments, and as previously described, the PCB 110 capacitively and/or inductively feeds the slot antenna (provided by the slot 108) via the coplanar coupling structure (the coupling trace 205A) that is connected to the matching and/or filter network 118, and which is parallel to a surface of the armature 102. In the example of the Z-shaped slot 108 shown, there may be some spurious signals (harmonics) generated due to coupling of the transmitter signal into the general-purpose input/output (GPIO) traces 209 (FIG. 4) that are parallel to the coupling trace 205B and connect to the radio chip 114. Nonlinear behavior of the GPIO circuitry can introduce harmonics to the transmitted signal. This effect has been shown to yield a limited margin for European Telecommunications Standards Institute (ETSI) and Federal Communications Commission (FCC) certification of about 6 dB. Thus, as described in more detail below with reference to FIG. 5, a V-shaped slot 109 may be implemented in some cases to minimize coupling from the GPIO traces 209, which are not part of the feeding structure (the coplanar coupling structure provided by the coupling trace 205A). Stated another way, the V-shaped slot 109 serves to keep RF energy away from the GPIO traces 209, thereby reducing the risk of spurious signals. In some embodiments, by implementing the V-shaped slot 109, the certification margin may be increased to about 10 dB, while not presenting any penalty on antenna efficiency. In various embodiments, and whether employing the Z-shaped shot 108 or the V-shaped slot 109, an antenna efficiency of about-3 dB may be provided.

With reference to FIG. 4, illustrated therein is a more detailed top-down perspective view of a portion of the PCB 110 mounted on the armature 102. The example of FIG. 4 illustrates the fasteners 202 (e.g., screws, bolts, rivets) that are used to mechanically, but not electrically attach the PCB 110 to the armature 102. FIG. 4 also shows various conductive traces on the PCB 110 such as the conductive traces 204 for mounting of the array of LEDs 112. As previously noted, conductive traces 205 are also provided. In particular, apart from the coupling traces 205A, 205B discussed above, the conductive traces 205 may provide a footprint and pin connection region 206 for the radio chip 114, a programming and debugging connection region 208, and a power supply and input/output (I/O) region 212. In some embodiments, the GPIO traces 209, or at least some of the GPIO traces 209, may be routed through the programming and debugging connection region 208 to couple the radio chip 114 to the power supply and I/O region 212. In the example of FIG. 4, the slot 108 is also shown as being disposed in the plane of the armature 102 beneath the PCB 110.

FIG. 5 illustrates another top-down perspective view of a portion of the PCB 110 mounted on the armature 102. The example of FIG. 5 illustrates the fasteners 202 and the conductive traces such as the conductive traces 204 for mounting of the array of LEDs 112. FIG. 5 also shows the footprint and pin connection region 206 for the radio chip 114, the programming and debugging connection region 208, and the power supply and I/O region 212, as discussed above with reference to FIG. 4. However, in contrast to the Z-shaped slot 108 shown in the previously described examples, the example of FIG. 5 includes a V-shaped slot 109 that is integral to the armature 102 and beneath the PCB 110. In some embodiments, an angle θ defined by the V-shaped slot 109 may be equal to about 45 degrees. More generally, in some embodiments, the angle θ may be in a range between about 40-50 degrees. Further, in at least some embodiments, the angle θ may be up to 90 degrees or generally in a range of between about 45-90 degrees. For larger values of θ, and in some cases, antenna properties (e.g., such as impedance, bandwidth, and/or efficiency) may change. By using the V-shaped slot 109, undesired coupling to the GPIO traces 209 (and/or undesired coupling from other electronic circuits present in the PCB 110 that do not belong to the feeding structure) can be minimized. Stated another way, by implementing the V-shaped slot 109, undesired generation and radiation of spurious signals (harmonics) is reduced and thereby improving the robustness of the system (e.g., such as for electromagnetic compliance regulation). In some embodiments and as with the Z-shaped slot 108, the PCB 110 may cover about half of the V-shaped slot 109, while the other half of the V-shaped slot 109 is adjacent to the PCB 110 (albeit further from the PCB 110 than the other half of the Z-shaped slot 108 that is adjacent to the PCB 110).

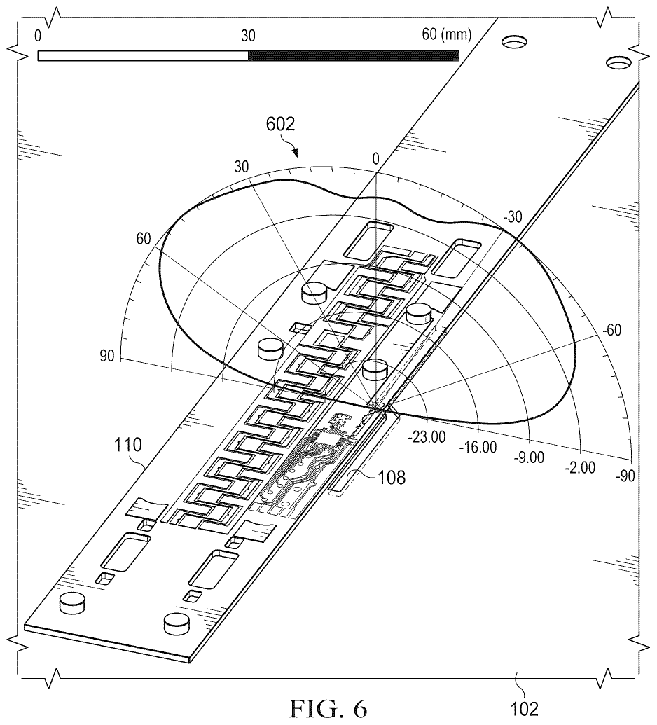

Turning now to FIGS. 6-10, illustrated therein are various exemplary simulation results for a light fixture including the Z-shaped slot 108 and the attached PCB 110, as described above, in accordance with some embodiments. In particular, FIG. 6 illustrates a top-down perspective view of a portion of the PCB 110 mounted on the armature 102, where the armature 102 includes the Z-shaped slot 108. FIG. 6 also shows an exemplary two-dimensional (2D) far-field plot 602 overlaid over the slot 108, which provides a 2D graphical representation of the radiation pattern of the slot antenna (provided by the Z-shaped slot 108) in a region above the slot antenna. As shown, the radiation emitted by the slot antenna, away from a plane of the armature 102 (the plane of the slot 108), is substantially uniform across directions.

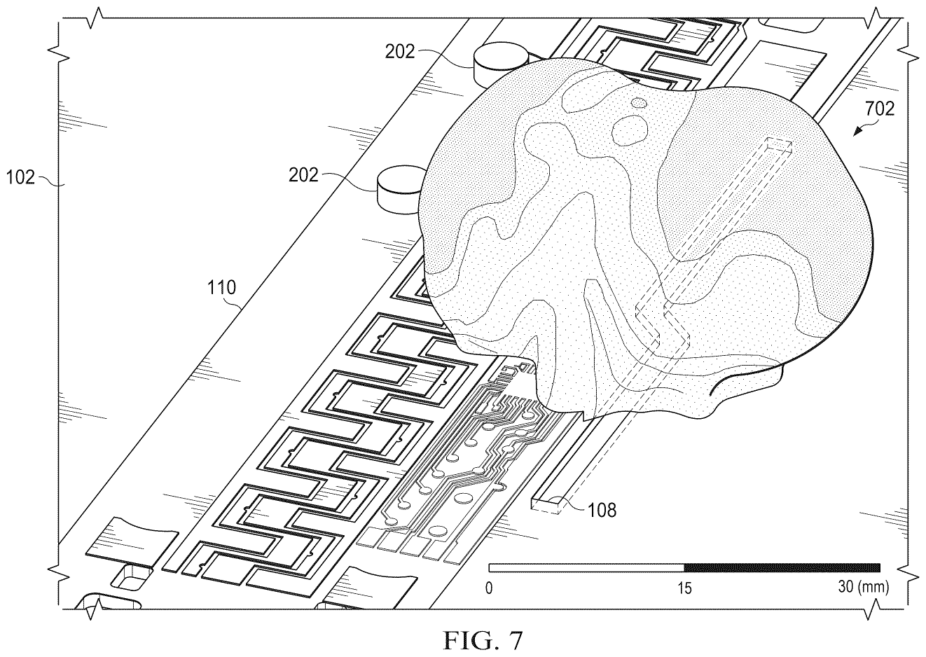

FIG. 7 illustrates a top-down perspective view of a portion of the PCB 110 mounted on the armature 102, where the armature 102 includes the Z-shaped slot 108. FIG. 7 also shows an exemplary three-dimensional (3D) far-field plot 702 overlaid over the slot 108, which provides a 3D graphical representation of the radiation pattern of the slot antenna (provided by the Z-shaped slot 108) in a region above the slot antenna. In the present example, the 3D far-field plot 702 may correspond to the 2D far-field plot 602, discussed above. The 3D far-field 702 further underscores that the radiation emitted by the slot antenna, away from a plane of the armature 102 (the plane of the slot 108), is substantially uniform across directions.

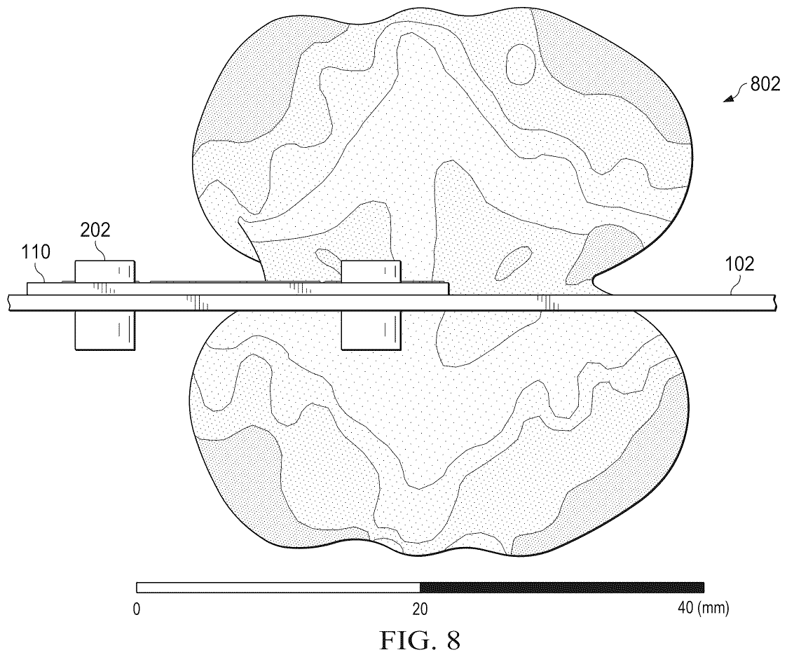

FIG. 8 illustrates a cross-sectional view of the PCB 110 mounted on the armature 102, where the armature 102 includes the Z-shaped slot 108. FIG. 8 also shows an exemplary 3D far-field plot 802 overlaid over the slot 108. In particular, in the example of FIG. 8, the 3D far-field plot 802 provides a 3D graphical representation of the radiation pattern of the slot antenna (provided by the Z-shaped slot 108) in regions both above and below the slot antenna. Although not explicitly shown in FIGS. 6-7, it will be understood that as with any slot antenna, radiation will be emitted on both sides of the slot. In the present example, the 3D far-field plot 802 may correspond to the 3D far field plot 702 and the 2D far-field plot 602, discussed above. The 3D far-field 802 also illustrates that the radiation emitted by the slot antenna, away from a plane of the armature 102 (the plane of the slot 108) and on both sides of the armature 102 (e.g., above and below the armature 102), is substantially uniform across directions.

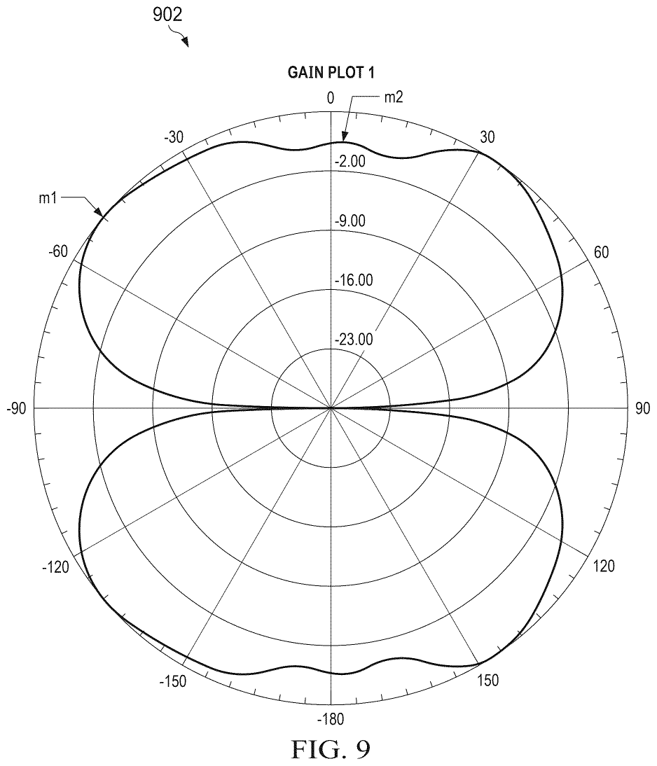

FIG. 9 illustrates an exemplary 2D far-field plot 902 (or gain plot) corresponding to the 3D far-field plot 802 of FIG. 8. In particular, the 2D far-field plot 902 may correspond to a cross-section of the 3D far-field plot 802 of FIG. 8, thereby providing a 2D graphical representation of the radiation pattern of the slot antenna (provided by the Z-shaped slot 108) in regions both above and below the slot antenna, and along a 2D section cut of the 3D far-field plot 802. Once again, and in the present example, the 2D far-field plot 902 also illustrates that the radiation emitted by the slot antenna, away from a plane of the armature 102 (the plane of the slot 108) and on both sides of the armature 102 (e.g., above and below the armature 102), is substantially uniform across directions.

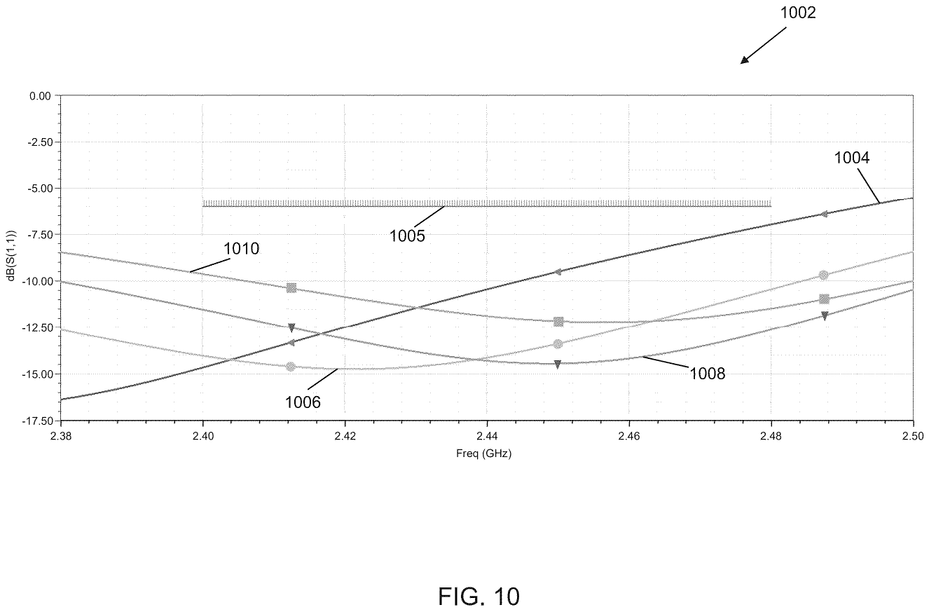

Referring to FIG. 10, illustrated therein is an exemplary S-parameter plot 1002 (or return loss plot 1002), in accordance with some embodiments. As shown, the S-parameter plot 1002 includes S11 parameters plotted as a function of frequency for different values of misalignment between the PCB 110 and the slot 108, such as discussed above with reference to FIG. 2. For reference, a bar 1005 is provided, where the bar 1005 is a limit line of −6 dB reflection coefficient within the Industrial Scientific Medical (ISM) frequency band (2.4-2.48 GHz). As shown in FIG. 10, the S-parameter plot 1002 includes a curve 1004 corresponding to a −1 mm offset in the Y-direction, a curve 1006 corresponding to a −0.5 mm offset in the Y-direction, a curve 1008 corresponding to a 0 mm offset in the Y-direction, and a curve 1010 corresponding to 0.5 mm offset in the Y-direction. For purposes of this discussion, it will be assumed that the example provided in FIG. 2 corresponds to a 0 mm offset in the Y-direction, where the edge 210 of the PCB 110 passes through the diagonal portion of the Z-shaped slot 108 and substantially bisects the slot 108 (e.g. covers half of the slot 108). In accordance with the present example, offset (or misalignment between the edge 210 of the PCB 110 and the slot 108) in the negative Y-direction will correspond to a case where the PCB 110 covers less than half of the slot 108, while an offset in the positive Y-direction would correspond to a case where the PCB 110 covers more than half of the slot 108. For the case of −1 mm offset in the Y-direction (curve 1004), the slot antenna has a resonance frequency of just below 2.38 GHz (about 2.37 GHz); for the case of −0.5 mm offset in the Y-direction (curve 1006), the slot antenna has a resonance frequency of about 2.42 GHz; for the case of 0 mm offset in the Y-direction (curve 1008), the slot antenna has a resonance frequency of about 2.45 GHz; and for the case of 0.5 mm offset in the Y-direction (curve 1010), the slot antenna has a resonance frequency of about 2.46 GHz. In various embodiments, and in view of the exemplary simulation results of FIG. 10, it is evident that the disclosed slot antenna can still present a matched impedance even for such a large manufacturing tolerance (e.g., misalignment tolerance). Stated another way, even with some misalignment between the PCB 110 and the slot 108, a robust slot antenna can still be provided. Further, while the example of FIG. 10 provides data for the case of offset in the Y-direction, it will be understood that similarly robust slot antennas can be provided for the case of offset in the X-direction, as well as for the case of offset in a Z-direction (e.g., such as for slight separation between the PCB 110 and the armature 102).

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A lighting device, comprising:
a printed circuit board (PCB) comprising a plurality of light-emitting diodes (LEDs) mounted on the PCB;
a radio communications module mounted on the PCB; and
a coplanar coupling structure coupled to the radio communications module;
wherein the PCB is configured to feed a slot antenna via the coplanar coupling structure, and wherein the slot antenna is disposed parallel to, and separated from, the coplanar coupling structure.

2. The lighting device of claim 1, further comprising:
a metal armature comprising an opening that defines a slot, wherein the slot provides the slot antenna;
wherein the PCB is mechanically attached to the metal armature.

3. The lighting device of claim 2, wherein the slot comprises a half-wavelength slot.

4. The lighting device of claim 2, wherein the metal armature is configured to provide a radiator for the slot antenna.

5. The lighting device of claim 2, wherein the slot comprises a Z-shaped slot or a V-shaped slot.

6. The lighting device of claim 1, wherein the PCB comprises a single-layer rigid PCB.

7. The lighting device of claim 2, wherein the mechanically attached PCB covers about half of the slot.

8. The lighting device of claim 1, wherein the PCB is configured to capacitively or inductively feed the slot antenna via the coplanar coupling structure.

9. The lighting device of claim 1, further comprising:
an LED driver mounted on the PCB, wherein the LED driver is coupled to the radio communications module and to the plurality of LEDs to drive the plurality of LEDs.

10. The lighting device of claim 1, further comprising:
a matching network coupled to the coplanar coupling structure and to an output of the radio communications module.

11. The lighting device of claim 1, wherein the coplanar coupling structure comprises a coupling trace, the coupling trace comprising a conductive trace of the PCB.

12. A lighting device, comprising:
an armature comprising a slot integral to the armature, wherein the slot provides the slot antenna;
a light-emitting diode (LED) strip printed circuit board (PCB) mechanically attached to the armature;
a radio chip mounted on the LED strip PCB and coupled to a coupling trace defined by a conductive trace of the LED strip PCB; and
wherein the LED strip PCB is configured to capacitively or inductively feed the slot antenna via the coupling trace.

13. The lighting device of claim 12, wherein the coupling trace defines a first conductive plane, and wherein the armature defines a second conductive plane parallel to the first conductive plane and separated from the first conductive plane by a distance substantially equal to a thickness of an insulating substrate of the LED strip PCB.

14. The lighting device of claim 12, wherein the slot comprises a Z-shaped slot or a V-shaped slot.

15. The lighting device of claim 12, wherein the LED strip PCB comprises a single-layer rigid PCB.

16. The lighting device of claim 12, wherein the LED strip PCB covers about half of the slot.

17. The lighting device of claim 12, wherein the radio chip comprises a radio frequency (RF) terminal that provides an RF output of the radio chip, and wherein the RF output is coupled to the coupling trace.

18. The lighting device of claim 17, wherein a matching network is coupled between the RF output and the coupling trace.

19. A lighting device, comprising:
an armature comprising a Z-shaped slot that provides a slot antenna; and
a printed circuit board (PCB) attached to the armature and covering about half of the Z-shaped slot;
wherein the PCB comprises an array of light-emitting diodes (LEDs), an LED driver coupled to the array of LEDs to drive the LEDs, and a radio chip coupled to the LED driver and to a matching network connected to an output of the radio chip;
wherein the matching network is further coupled to a conductive coupling trace of the PCB; and
wherein the PCB is configured to capacitively or inductively feed the Z-shaped slot via the conductive coupling trace.

20. The lighting device of claim 19, wherein the Z-shaped slot has a first length that is equal to about half a wavelength of a target frequency, and wherein the conductive coupling trace has a second length that is equal to about a quarter of the wavelength of the target frequency.
